(19) United States
(12) Patent Application Publication
(10) Pub. No.: US 2004/0029758 A1
(43) Pub. Date: Feb. 12, 2004

(54) Method of circulating water in circulatory water tank system and liquid composition for sterilizing and disinfecting circulatory water tank system

(76) Inventors: Masashi Yoshida, Chiba (JP); Shigetoshi Yoshida, Chiba (JP)

Correspondence Address: Darby & Darby, Post Office Box 5257, New York, NY, 10150-5257, US

(21) Appl. No.: 10/398,948

(22) PCT Filed: Mar. 30, 2001
(86) PCT No.: PCT/JP01/02745

(30) Foreign Application Priority Data
Oct. 12, 2000 (JP) 2000-312049

(51) Int. Cl. C11D 1/00

(52) U.S. Cl. 510/247

(57) ABSTRACT

Disclosed is a method for circulating water through a circulating tub system, which method gives no harm to human body and no damage to the system, is capable of inhibiting formation of biofilms wherein Legionella inhibit, and circulates water while bacteria such as Legionella, Pseudomonas aeruginosa, and Escherichia coli are effectively sterilized and disinfected, and while foaming is suppressed. The method includes circulating, through water circulation piping of a circulating tub system, water containing a quaternary ammonium salt, 2-phenoxyethanol, and an antifoaming agent, wherein a total concentration of the quaternary ammonium salt and the 2-phenoxyethanol is 10 to 100 ppm.

The present invention relates to a method for circulating water through a circulating tub system having a water or hot water circulation system, such as public baths, household baths, and indoor and outdoor swimming pools, and to a sterilizing, disinfecting liquid composition for a circulating tub system for use in the method. More specifically, the present invention relates to a method for circulating water through a circulating tub system which causes no harm to human body and no damage to the system, which is capable of inhibiting formation of biofilms wherein bacteria of the genus Legionella or the like inhabit, and which enables circulation of water while bacteria such as those of the genus Legionella, Pseudomonas aeruginosa, and Escherichia coli are effectively disinfected or sterilized, and to a sterilizing, disinfecting liquid composition for a circulating tub system for use in the method.

### BACKGROUND ART

Circulating tub systems having a water or hot water circulation system, such as those of public baths, household baths, and indoor and outdoor swimming pools, are usually provided with a device for removing large pollutants, such as prefilters and hair catchers, and a filtering device loaded with a filter medium, in the circulation piping for water purification. In addition, for sterilization and disinfection of the systems, a sodium hypochlorite solution or sodium isocyanurate is usually dissolved at a predetermined concentration in the water or hot water circulating through the systems. Further, ozone, ultraviolet rays, photocatalysts, or chlorinating agents are sometimes used for disinfecting only the bath water.

However, even the circulating tub systems subjected to such purification or sterilization are not irrelevant to the recent concerns about the risk of infection with Legionnaire's disease. In the circulating tubs, in particular, whirlpool baths, bubbling baths, and Jacuzzi baths, aerosol is generated, which may be inhaled into the respiratory system of the bathers. Thus the problem of infection needs urgent attention.

The Legionnaire's disease may be caused by biofilms of chlorine resistant bacteria or algae formed in tortuous piping and connections of a circulating tub system, and in the parts of a septic tank that are hard to be cleaned physically. The biofilms may contain Legionella, to which bacteria the chlorine sanitizers such as a sodium hypochlorite solution do not exhibit the desired effect. Formation of the biofilms may be observed only in a few months even when the water or hot water in a newly-built circulating tub system is drained everyday. The biofilms are seldom formed at physically cleanable locations, and require chemical cleaning for removal. However, sufficient removal of biofilms cannot actually be achieved at the conventional concentration of the chlorine sanitizer.

In order to prevent formation of biofilms, the concentration of the chlorine sanitizer may possibly be raised. There has been reported, however, that an increased concentration of the chlorine sanitizer damaged a circulating tub system, which indicates a problematic nature of the chlorine sanitizer to cause serious damage to the system. Thus the concentration of the sanitizer cannot be raised to such an extent as to prevent formation of biofilms. The increased concentration of the chlorine sanitizer also has an adverse effect on human body, so that the upper limit of the concentration cannot be extended. In addition, the chlorine sanitizers have a characteristic odor, which makes the bathers unpleasant when the concentration is raised.

### DISCLOSURE OF THE INVENTION

It is an object of the present invention to provide a method for circulating water through a circulating tub system, and a sterilizing, disinfecting liquid composition for a circulating tub system for use in the method, which causes no harm to human body and no damage to the system, which is capable of inhibiting formation of biofilms wherein Legionella inhabit, and which enables circulation of water while bacteria such as Legionella, P. aeruginosa, and E. coli are effectively disinfected or sterilized and while foaming is suppressed.

It is another object of the present invention to provide a sterilizing, disinfecting liquid composition for a circulating tub system which does not have the characteristic odor of chlorine sanitizers, which inhibits formation of biofilms wherein Legionella inhabit, and which is capable of effectively disinfecting or sterilizing bacteria such as Legionella, P. aeruginosa, and E. coli.

The present inventors have made intensive studies for accomplishing the above objects to find out that, by circulating, through the system, the circulation water in which a quaternary ammonium salt and 2-phenoxyethanol have been dissolved at a particular concentration that causes no harm to human body and no damage to the system, formation of biofilms wherein Legionella inhabit may be inhibited, which cannot be achieved with chlorine sanitizers, and bacteria such as Legionella, P. aeruginosa, and E. coli may be effectively disinfected or sterilized. The inventors have also found out that the above objects may be accomplished by dissolving a quaternary ammonium salt and 2-phenoxyethanol in the circulation water or hot water at a particular concentration, and using a particular alcohol as a solvent and adding a particular amount of an antifoaming agent for preventing foaming, which is unpleasant to the bathers, to thereby complete the present invention.

According to the present invention, there is provided a method for circulating water through a circulating tub system comprising circulating, through a water circulation piping of a circulating tub system, water comprising a quaternary ammonium salt, 2-phenoxyethanol, and an antifoaming agent, wherein a total concentration of said quaternary ammonium salt and said 2-phenoxyethanol is 10 to 100 ppm.

According to the present invention, there is also provided a sterilizing, disinfecting liquid composition for a circulating tub system, comprising a quaternary ammonium salt, 2-phenoxyethanol, an alcohol capable of dissolving said quaternary ammonium salt and said 2-phenoxyethanol, and an antifoaming agent, wherein said composition is for use by dissolving in a circulating water in a circulating tub system.

### PREFERRED EMBODIMENTS OF THE INVENTION

The present invention will now be explained in detail.

The method for circulating water through a circulating tub system according to the present invention is for circulating tub systems equipped with a water circulator, such as public baths including public spas, natural spas, baths in accommodation facilities, and baths in nursing homes; household baths; and indoor and outdoor swimming pools. In short, the present method is for circulating water safely while bathers or the like are in the water. The present method for circulating water is particularly effective for circulating water through circulating tub systems having an aerosol-generating bath, such as a whirlpool bath, a bubbling bath, a Jacuzzi bath, or a combination of these. As used herein, the “water” to be circulated includes hot water.

The method for circulating water according to the present invention is characterized by circulating, through a circulating tub system, water containing a quaternary ammonium salt and 2-phenoxyethanol at a particular concentration, and also containing an antifoaming agent.

Examples of the quaternary ammonium salt may include octyltrimethylammonium chloride, decyltrimethylammonium chloride, dodecyltrimethylammonium chloride, tetradecyltrimethylammonium chloride, hexadecyltrimethylammonium chloride, octadecyltrimethylammonium chloride, octadecenyltrimethylammonium chloride, octadecadienyltrimethylammonium chloride, dioctyltrimethylammonium chloride, didecyltrimethylammonium chloride, didodecyltrimethylammonium chloride, ditetradecyltrimethylammonium chloride, dihexadecyltrimethylammonium chloride, dioctadecyltrimethylammonium chloride, dioctadecenyltrimethylammonium chloride, dioctadecadienyltrimethylammonium chloride, octyldimethylethylammonium chloride, decyldimethylethylammonium chloride, dodecyldimethylethylammonium chloride, tetradecyldimethylethylammonium chloride, hexadecyldimethylethylammonium chloride, octadecyldimethylethylammonium chloride, octadecenyldimethylethylammonium chloride, octadecadienyldimethylethylammonium chloride, dioctyldimethylethylammonium chloride, didecyldimethylethylammonium chloride, didodecyldimethylethylammonium chloride, ditetradecyldimethylethylammonium chloride, dihexadecyldimethylethylammonium chloride, dioctadecyldimethylethylammonium chloride, dioctadecenyldimethylethylammonium chloride, dioctadecadienyldimethylethylammonium chloride, octyldimethylbenzylammonium chloride, decyldimethylbenzylammonium chloride, dodecyldimethylbenzylammonium chloride, tetradecyldimethylbenzylammonium chloride, hexadecyldimethylbenzylammonium chloride, octadecyldimethylbenzylammonium chloride, octadecenyldimethylbenzylammonium chloride, octadecadienyldimethylbenzylammonium chloride, dioctyldimethylbenzylammonium chloride, didecyldimethylbenzylammonium chloride, didodecyldimethylbenzylammonium chloride, ditetradecyldimethylbenzylammonium chloride, dihexadecyldimethylbenzylammonium chloride, dioctadecyldimethylbenzylammonium chloride, dioctadecenyldimethylbenzylammonium chloride, dioctadecadienyldimethylbenzylammonium chloride, or mixtures thereof. Commercially available products, for example “ARQUD CB-50” and “ARQUD S-50”, both manufactured by LION AKZO CO., LTD., may also be used.

There is no particular limitation imposed on the antifoaming agent, and silicon antifoaming agents may preferably be used. The concentration of the antifoaming agent may be sufficient if it prevents generation of foam caused by the quaternary ammonium salt during circulation of water or hot water, and may suitably be selected.

In the present method for circulating water, the total concentration of the quaternary ammonium salt and 2-phenoxyethanol in the circulating water or hot water, is 10 to 100 ppm, preferably 20 to 80 ppm, 30 to 80 ppm. With the concentration of less than 10 ppm, the desired effect may not be obtained sufficiently, whereas with the concentration exceeding 100 ppm, the effect is not improved in proportion to the amount, thus not being economical.

The ratio of the quaternary ammonium salt to 2-phenoxyethanol may suitably be decided, but is usually 30:70 to 70:30, preferably 40:60 to 60:40 by weight.

In the present method for circulating water, the circulating water may optionally contain other components, such as other sterilizing or disinfecting agents or alcohols, in a suitable amount, as long as the objects of the present invention are not impaired, or for further improving the above-mentioned and other objects of the invention. It should be noted that, when chlorine sanitizers are used, which have a characteristic odor, their amount is preferably kept as small as possible.

In the present method for circulating water, the concentration of the quaternary ammonium salt and 2-phenoxyethanol is adjusted preferably by means of a device that is capable of adding the sterilizing, disinfecting liquid composition to be discussed later, in response to the need due to increase or decrease of the water, depending on the circulating tub system through which the water is circulated, in order to circulate water containing the above-mentioned specific concentration of the quaternary ammonium salt and 2-phenoxyethanol.

In the present method for circulating water, it is preferred to drain the circulating water and introduce a fresh circulating water, to which a fresh sterilizing, disinfecting liquid composition to be discussed later is added, at least every 30 days, though the interval may suitably be decided depending on the number of bathers, the amount of water, or the like factor.

In practicing the present method for circulating water, dissolving the quaternary ammonium salt, 2-phenoxyethanol, and the antifoaming agent in the circulating water, may be performed by adding and dissolving a suitable amount of the sterilizing, disinfecting liquid composition of the present invention to be discussed later in the circulating water. The composition may be added to the circulating water at one location, but is preferably added in portions at a plurality of locations.

The sterilizing, disinfecting liquid composition for a circulating tub system according to the present invention is for use by dissolving it in the circulating water in a circulating tub system. The composition is capable of inhibiting or preventing generation of bacteria such as Legionella without health hazard, for example in a public bath, even while bathers are taking the bath. The sterilizing, disinfecting liquid composition of the present invention contains a quaternary ammonium salt, 2-phenoxyethanol, an alcohol capable of dissolving the quaternary ammonium salt and 2-phenoxyethanol, and an antifoaming agent.

The alcohol may be, for example, ethanol, isopropyl alcohol, or a mixture thereof. Without the alcohol, the quaternary ammonium salt and 2-phenoxyethanol cannot be dissolved sufficiently in the circulating water in the circulating tub system, making it difficult to achieve the predetermined concentration of these two components in the circulating water.

In the sterilizing, disinfecting liquid composition of the present invention, with regard to the ratio of the quaternary ammonium salt, 2-phenoxyethanol, the alcohol capable of dissolving these, and the antifoaming agent, the ratio of the quaternary ammonium salt to 2-phenoxyethanol may usually be 30:70 to 70:30, preferably 40:60 to 60:40, and the amount of the alcohol may be for dissolving these two components or more, and the amount of the antifoaming agent may be for suppressing generation of foam due to the quaternary ammonium salt.

Safety of a mixture of the quaternary ammonium salt and 2-phenoxyethanol used in the present invention has been confirmed even at a concentration of 5000 mg/kg (LD₅₀) in an oral toxicity test.

The sterilizing, disinfecting liquid composition of the present invention may optionally contain other components as desired. Such other components may be, for example, other sterilizing or disinfecting agents, or solubilizing agents other than the above-mentioned alcohol. The mixing ratio of the other components may suitably be selected depending on the need.

The sterilizing, disinfecting liquid composition of the present invention may be prepared by mixing the components so that the quaternary ammonium salt and 2-phenoxyethanol are dissolved.

According to the present method for circulating water through a circulating tub system, the quaternary ammonium salt and 2-phenoxyethanol are dissolved in the circulating water at a predetermined concentration, and circulated through the system, so that formation of biofilms wherein bacteria such as Legionella inhabit, may be inhibited, and other common bacteria and E. coli may be sterilized effectively, both of which cannot sufficiently be achieved with chlorine sanitizers. Such inhibition of biofilm formation and sterilization are realized without health hazard and any damage to the system. Further, since the antifoaming agent is also added to the circulating water, foaming due to the quaternary ammonium salt may also be suppressed. In addition, omission of a chlorine sanitizer from the essential components realizes suppression and prevention of the characteristic unpleasant odor of chlorine.

The sterilizing, antifoaming liquid composition for a circulating tub system according to the present invention contains a particular alcohol and an antifoaming agent as well as a quaternary ammonium salt and 2-phenoxyethanol dissolved therein, so that a predetermined amount of the quaternary ammonium salt and 2-phenoxyethanol may easily be dissolved in the circulating water or hot water in practicing the above method for circulating water, and the desired effects may be obtained.

### EXAMPLES

The present invention will now be explained in more detail with reference to Examples and Comparative Examples, which are illustrative only, and do not intend to limit the present invention.

### Example 1

320 parts by weight of alkyltrimethylammonium salt as a quaternary ammonium salt, 300 parts by weight of 2-phenoxyethanol, 340 parts by weight of isopropyl alcohol, and 4 parts by weight of silicon antifoaming agent were mixed to prepare a sterilizing, disinfecting liquid for a circulating tub system.

A circulating bath tub containing a total of 5000 m³ of a medicated bath water was tested for Legionella in accordance with a common procedure, and was found negative. To this medicated bath water, 250 ml of the sterilizing, disinfecting liquid cleaner prepared above (the total concentration of the quaternary ammonium salt and 2-phenoxyethanol was 50 ppm) was added, and the bath water was circulated for three days with the concentration being kept by adding the sterilizing, disinfecting liquid, while about 1000 bathers per day used the bath. The bath water was tested for Legionella everyday in accordance with a common procedure, and was found negative all through the three days.

### Comparative Example 1

The bathing and the test for Legionella were performed in the same way as in Example 1, except that the sterilizing, disinfecting liquid prepared in Example 1 was not used, and the concentration of sodium hypochlorite was kept at 5 to 10 ppm. As a result, Legionella were detected at the end of the first day.

### Example 2

300 parts by weight of a commercially available product “ARQUD CB-50” (manufactured by LION AKZO CO., LTD.) as a quaternary ammonium salt, 350 parts by weight of 2-phenoxyethanol, 310 parts by weight of isopropyl alcohol, and 4 parts by weight of silicon antifoaming agent were mixed to prepare a sterilizing, disinfecting liquid for a circulating tub system.

A circulating bath tub containing a total of 6000 m³ of bath water was tested for Legionella in accordance with a common procedure, and was found negative. To this bath water, 300 ml of the sterilizing, disinfecting liquid prepared above (the total concentration of the quaternary ammonium salt and 2-phenoxyethanol was 50 ppm) was added, and the bath water was circulated for three days with the concentration being kept by adding the sterilizing, disinfecting liquid, while about 1500 bathers per day used the bath. The bath water was tested for Legionella everyday in accordance with a common procedure, and was found negative all through the three days.

### Comparative Example 2

The bathing and the test for Legionella were performed in the same way as in Example 2, except that the sterilizing, disinfecting liquid prepared in Example 2 was not used, and the concentration of sodium hypochlorite was kept at 2 to 5 ppm. As a result Legionella were detected at the end of the first day.

### Comparative Example 3

In a newly-built large bath having four bath tub systems, one of the bath tub systems, which was an open air bath, was tested for Legionella in accordance with a common procedure in the third month of business, and 300 CFU/100 ml of bacteria of the genus Legionella were detected. Then the concentration of sodium hypochlorite was set so that the maximum level of free residual chlorine was 2 mg/l, and the bath water was circulated through the bath tub systems for 2 hours. Subsequently, the baths were operated for 3 days with the concentration of sodium hypochlorite being kept at 0.4 mg/l, which is within the safe range for human body, while 2000 bathers per day used the bath. After the three days of operation, the bath water was tested for Legionella, and it was found that the count of the bacteria of the genus Legionella was increased to 1300 CFU/100 ml.

### Example 3

To the four bath tub systems (containing a total of 70000 liters of bath water), in which 1300 CFU/100 ml of Legionella was detected in Comparative Example 3, 3.5 liters of the sterilizing, disinfecting liquid prepared in Example 2 was introduced. When the bath water was circulated for one cycle, a large amount of biofilms flew out. After the bath water was drained twice, the fresh bath water was tested for bacteria of the genus Legionella and other common bacteria, and was found negative for both. Then the baths were operated for 7 days with the concentration of the sterilizing, disinfecting liquid prepared in Example 2 being 50 ppm, and the chlorine concentration being 0.4 mg/l, which corresponded to a high chlorine level contained in ordinary tap water, while 2000 bathers per day used the bath. After the seven days of operation, the bath water was tested for Legionella and other common bacteria, and was found negative for both.

### Example4

A circulating bath tub containing a total of 70000 m³ of bath water was tested for Legionella in accordance with a common procedure, and was found negative. This bath water was circulated for 30 days for operation, while the total concentration of the quaternary ammonium salt and 2-phenoxyethanol was kept in the range of 10.02 to 10.05 ppm by adding the sterilizing, disinfecting liquid prepared in Example 2 by means of a power injector having a concentration detector. The bath water was tested for Legionella and E. coli. every week, and was found all negative. On the other hand, the water containing a total of about 10 ppm of the quaternary ammonium salt and 2-phenoxyethanol was confirmed to be safe for drinking.

What is claimed is:

1. A method for circulating water through a circulating tub system comprising circulating, through water circulation piping of a circulating tub system, water containing a quaternary ammonium salt, 2-phenoxyethanol, and an antifoaming agent, wherein a total concentration of said quaternary ammonium salt and said 2-phenoxyethanol is 10 to 100 ppm.

2. The method of claim 1, wherein a ratio of said quaternary ammonium salt to said 2-phenoxyethanol is 30:70 to 70:30 by weight.

3. The method of claim 1, wherein said circulating tub system comprises a whirlpool bath, a bubbling bath, a jacuzzi bath, or a combination thereof, which generates aerosol.

4. A sterilizing, disinfecting liquid composition for a circulating tub system, comprising a quaternary ammonium salt, 2-phenoxyethanol, an alcohol capable of dissolving said quaternary ammonium salt and said 2-phenoxyethanol, and an antifoaming agent, wherein said composition is for use by dissolving in a circulating water in a circulating tub system.

5. The sterilizing, disinfecting liquid composition of claim 4, wherein said alcohol is selected from the group consisting of ethanol, isopropyl alcohol, and mixtures thereof.

6. The sterilizing, disinfecting liquid composition of claim 4, wherein a ratio of said quaternary ammonium salt to said 2-phenoxyethanol is 30:70 to 70:30 by weight.
